(19) United States
(12) Patent Application Publication
(10) Pub. No.: US 2016/0124235 A1
(43) Pub. Date: May 5, 2016

(54) INTEGRAL IMAGING THREE-DIMENSIONAL LIQUID CRYSTAL DEVICE AND THE ADOPTED OPTICAL APPARATUS THEREOF

(71) Applicant: Shenzhen China Star Optoelectronics Technology Co. Ltd., Shenzhen, Guangdong (CN)

(72) Inventor: Bin FANG, Shenzhen, Guangdong (CN)

(73) Assignee: Shenzhen China Star Optoelectronics Technology Co. Ltd., Shenzhen, Guangdong (CN)

(21) Appl. No.: 14/402,101

(22) PCT Filed: Nov. 10, 2014
(86) PCT No.: PCT/CN2014/090674

§ 371 Date: Nov. 18, 2014

(30) Foreign Application Priority Data
Oct. 31, 2014 (CN) 2014106063818

(51) Int. Cl. G02B 27/22; G02F 1/1343; G02F 1/137

(52) U.S. Cl. CPC G02B 27/2214; G02F 1/137; G02F 1/13439

(57) ABSTRACT

An integral imaging 3D LCD and the optical apparatus thereof are disclosed. The integral imaging 3D LCD includes a lens array, a display panel, a light-tuning panel arranged between the lens array and the display panel. The display panel comprises a plurality of light-tuning units corresponding to different lens or different combinations of the lens of the lens array, the light-tuning panel remains in the same position with respect to the lens array and the display panel during operations. The light-tuning unit comprises electrodes and light-tuning material, when the electrodes are applied with a voltage, the light-tuning material transmits light beams from the display panel to the lens array to change a transmission direction of the light beams. In this way, the viewing angle of the integral imaging 3D LCD is enlarged.

### BACKGROUND OF THE INVENTION

1. Field of the Invention

The present disclosure relates to three-dimensional (3D) display technology, and more particularly to an integral imaging 3D liquid crystal device (LCD) and the adopted optical apparatus thereof.

2. Discussion of the Related Art

Integral imaging usually adopt microlens array to record 3D scenes, and the microlens array with the same parameters is adopted to display the 3D image. Afterward, the 3D images and the 3D scenes with the same color and depth are re-produced according to the reversed optical path principle, which is also referred to as real 3D display.

The viewing angle is a very important parameters for integral imaging 3D display, which refers to the viewing angle without no crack and no transition. A larger 3D viewing angle provides higher flexibility.

Currently, dynamic moving barrier that can be mechanically controlled is arranged between the lens array and the LCD. The spreading direction of light beams emitted by the LCD may be adjusted by the movement of the barrier. The viewing angle may be enlarged by moving the barrier and displaying the pixel images displayed at the same, wherein the images may change during the movement. However, such mechanical control mechanism may be difficult during the manufacturing process. In addition, it is also difficult to precisely control the location of the barrier.

### SUMMARY

The object of the claimed invention is to provide an integral imaging 3D LCD and the adopted optical apparatus to enlarge the viewing angle of the 3D LCD.

In one aspect, an integral imaging 3D LCD includes: a lens array, a display panel, a light-tuning panel arranged between the lens array and the display panel, the display panel comprises a plurality of light-tuning units corresponding to different lens or different combinations of the lens of the lens array, the light-tuning panel remains in the same position with respect to the lens array and the display panel during operations, the light-tuning unit comprises electrodes and light-tuning material, when the electrodes are applied with a voltage, the light-tuning material transmits light beams from the display panel to the lens array to change a transmission direction of the light beams; the light-tuning material is liquid crystal molecule, alignment of liquid crystal molecules is changed due to an electrical field formed when the electrodes are applied with a first voltage, the liquid crystal molecule is equivalent to a prism having a first shape so as to transmit the light beams to a left eye after being passed through the lens array, and the alignment of the liquid crystal molecules is changed or remains the same in accordance with a second voltage applied to the electrodes, the liquid crystal molecule is equivalent to the prism having a second shape so as to transmit the light beams to a right eye after being passed through the lens array; a dimension of the light-tuning unit is the same with the dimension of the lens unit of the lens array along with a horizontal direction of the lens array and the display panel, and borders of the adjacent light-tuning units align with a center of the lens unit; and the electrodes comprises a first transparent electrode and a second transparent electrode, and at least one of the first transparent electrode and the second transparent electrode forms an electrical field after being applied with the voltage.

Wherein the first transparent electrode and the second transparent electrode are arranged at respective sides of the lens array and the display panel close to the liquid crystal layer, or the first transparent electrode and the second transparent electrode are both arranged at one side of the lens array or the display panel.

In another aspect, an integral imaging 3D LCD includes: a lens array, a display panel, and a light-tuning panel arranged between the lens array and the display panel, the display panel comprises a plurality of light-tuning units corresponding to different lens or different combinations of the lens of the lens array, the light-tuning panel remains in the same position with respect to the lens array and the display panel during operations, the light-tuning unit comprises electrodes and light-tuning material, when the electrodes are applied with a voltage, the light-tuning material transmits light beams from the display panel to the lens array to change a transmission direction of the light beams.

Wherein the light-tuning material is liquid crystal molecule, alignment of liquid crystal molecules is changed due to an electrical field formed when the electrodes are applied with a first voltage, the liquid crystal molecule is equivalent to a prism having a first shape so as to transmit the light beams to a left eye after being passed through the lens array, and the alignment of the liquid crystal molecules is changed or remains the same in accordance with a second voltage applied to the electrodes, the liquid crystal molecule is equivalent to the prism having a second shape so as to transmit the light beams to a right eye after being passed through the lens array.

Wherein a dimension of the light-tuning unit is the same with the dimension of the lens unit of the lens array along with a horizontal direction of the lens array and the display panel, and borders of the adjacent light-tuning units align with a center of the lens unit.

Wherein the electrodes comprises a first transparent electrode and a second transparent electrode, and at least one of the first transparent electrode and the second transparent electrode forms an electrical field after being applied with the voltage.

Wherein the first transparent electrode and the second transparent electrode are arranged at respective sides of the lens array and the display panel close to the liquid crystal layer, or the first transparent electrode and the second transparent electrode are both arranged at one side of the lens array or the display panel.

In another aspect, an optical apparatus for an integral imaging 3D LCD includes: a lens array, a display panel, a light-tuning panel arranged between the lens array and the display panel, the display panel comprises a plurality of light-tuning units corresponding to different lens or different combinations of the lens of the lens array, the light-tuning panel remains in the same position with respect to the lens array and the display panel during operations, the light-tuning unit comprises electrodes and light-tuning material, when the electrodes are applied with a voltage, the light-tuning material transmits light beams from the display panel to the lens array to change a transmission direction of the light beams.

Wherein the light-tuning material is liquid crystal molecule, alignment of liquid crystal molecules is changed due to an electrical field formed when the electrodes are applied with a first voltage, the liquid crystal molecule is equivalent to a prism having a first shape so as to transmit the light beams to a left eye after being passed through the lens array, and the alignment of the liquid crystal molecules is changed or remains the same in accordance with a second voltage applied to the electrodes, the liquid crystal molecule is equivalent to the prism having a second shape so as to transmit the light beams to a right eye after being passed through the lens array.

Wherein a dimension of the light-tuning unit is the same with the dimension of the lens unit of the lens array along with a horizontal direction of the lens array and the display panel, and borders of the adjacent light-tuning units align with a center of the lens unit.

Wherein the electrodes comprises a first transparent electrode and a second transparent electrode, and at least one of the first transparent electrode and the second transparent electrode forms an electrical field after being applied with the voltage.

Wherein the first transparent electrode and the second transparent electrode are arranged at respective sides of the lens array and the display panel close to the liquid crystal layer, or the first transparent electrode and the second transparent electrode are both arranged at one side of the lens array or the display panel.

Wherein the first transparent electrode and the second transparent electrode are arranged at respective sides of the lens array and the display panel close to the liquid crystal layer, or the first transparent electrode and the second transparent electrode are both arranged at one side of the lens array or the display panel.

In view of the above, the integral imaging 3D LCD includes a lens array, a display panel, and a light-tuning panel arranged between the lens array and the display panel. By adjusting the voltage applied to the electrodes, the light-tuning material is capable of controlling the transmitting directions of the light beams. Comparing to the conventional display device while the movement of the mechanically controlled barrier is adopted to control the light beams, the claimed configuration not only ensures the life cycle of the display device, but also can be easily implemented and controlled.

### BRIEF DESCRIPTION OF THE DRAWINGS

FIG. 1 is a schematic view illustrating one conventional principle of integral imaging.

FIG. 2 is a schematic view showing the viewing angle of one conventional integral imaging 3D LCD.

FIG. 3 is a schematic view showing the enlarged viewing angle of one conventional integral imaging 3D LCD.

FIG. 4 is a schematic view of the integral imaging 3D LCD in accordance with one embodiment.

FIG. 5 is a schematic view of the structure and the optical path of the integral imaging 3D LCD in accordance with another embodiment.

FIG. 6 is a schematic view showing the viewing angle of the integral imaging 3D LCD in accordance with one embodiment.

FIG. 7 is a schematic view of the optical apparatus in accordance with one embodiment.

FIG. 8 is a schematic view of the optical apparatus in accordance with another embodiment.

### DETAILED DESCRIPTION OF THE EMBODIMENTS

Embodiments of the invention will now be described more fully hereinafter with reference to the accompanying drawings, in which embodiments of the invention are shown.

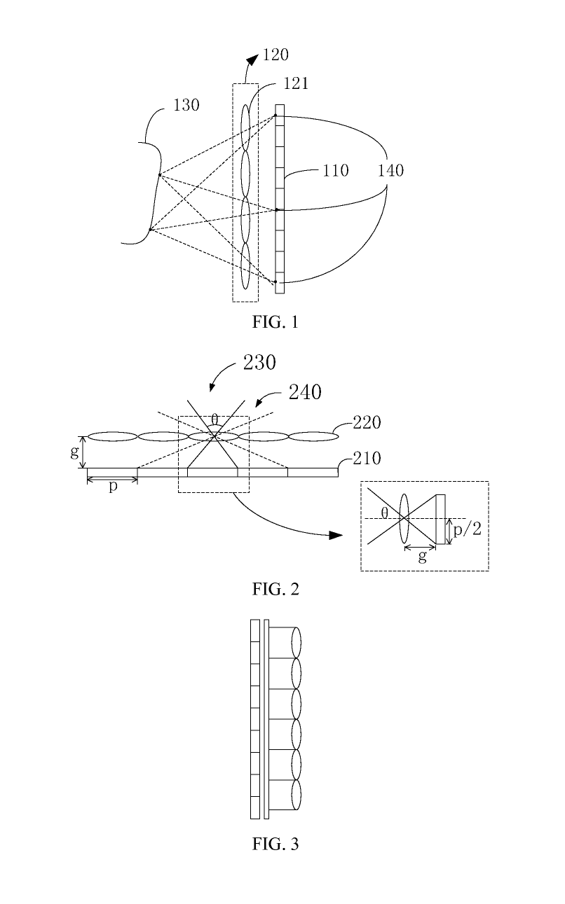

Integral imaging technology is a real 3D display technology by documenting the 3D scenes with the microlens array, which includes a collecting and an image reconstruction phases. FIG. 1 is a schematic view illustrating one conventional principle of integral imaging. During the collecting phase, a recording object 130 emits the light beams passing through each of the lens 121 of the lens array 120. The light beams recorded a 2D image on the corresponding location of the sensors 110. Each of the 2D images is referred to as an element image 140. The element images 140 corresponding to the lens 120 construct an element image array for collecting the information of the 3D objects or the 3D scenes so as to obtain the image micro array at different viewing angles.

During the image reconstruction phase, the light beams emitted by the recorded element micro array are reversed. According to the reversed optical path principle, the collected 3D objects or 3D scenes may be reconstructed such that users may enjoy the 3D effects without glasses.

FIG. 2 is a schematic view showing the viewing angle of one conventional integral imaging 3D LCD. FIG. 2 includes a sensor 210, a lens array 220, a normal observing area 230, a cross-talk observing area 240. θ relates to the viewing angle within the normal observing area 230, g relates to the distance between the lens and the sensors, and p relates to the lens pitch. The vertical-bisection line of the lens pitch is the angle bisection line of the normal observing area 230. The distance (g) between the lens and the sensors and half of the lens pitch (p) forms a vertex angle of one right-angled triangle, and the vertex angle is about half of the viewing angle (θ) of the normal observing area 230. According to the attribute of the right-angled triangle,

$$tan \frac{θ}{2} = \frac{p}{2 g} ,$$

and thus the observed angle is

$$θ = 2 arctan \frac{p}{2 g} .$$

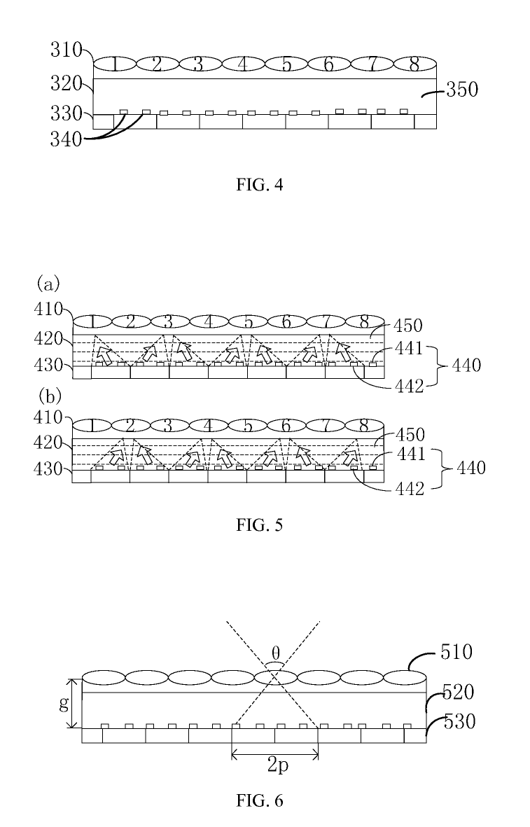

FIG. 4 is a schematic view of the integral imaging 3D LCD in accordance with one embodiment. The integral imaging 3D LCD includes a lens array 310, a display panel 330, and a light-tuning panel 320 arranged between the lens array 310 and the display panel 330. The light-tuning panel 320 includes a plurality of light-tuning units corresponding to different lens or different combinations of the lens of the lens array 310. For instance, the lens array 310 includes eight lens units numbered as 1 through 8. During the operations, the light-tuning panel 320 remains in the same position with respect to the lens array 310 and the display panel 330. In addition, the integral imaging 3D LCD includes a plurality of electrodes 340 and light-tuning material 350. When the voltage is applied to the electrodes 340, the light-tuning material 350 changes the transmitting direction of the light beams emitted from the display panel 330 toward the lens array 310. The left-eye image and the right-eye image are respectively transmitted. When the left-eye image is transmitted, an adjusting voltage may cause the light beams sent from the display panel 330 toward the lens array 310 to be transmitted to the left eye. When the right-eye image is transmitted, the adjusting voltage may cause the light beams sent from the display panel 330 toward the lens array 310 to be transmitted to the right eye.

The left-eye image and the right-eye image are alternately displayed by respectively transmitting the left-eye image to the left eye and transmitting the right-eye image to the right eye via the light-tuning panel. The left eye and right eye may observe different images, i.e., the left-eye image and the right-eye image do experience the 3D effect due to the persistence of vision effect.

FIG. 5 is a schematic view of the structure and the optical path of the integral imaging 3D LCD in accordance with another embodiment. The integral imaging 3D LCD includes a lens array 410, a display panel 430, and a light-tuning panel 420 including a plurality of light-tuning units. The integral imaging 3D LCD also includes electrodes 440 and light-tuning material 450. The electrodes 440 includes a first transparent electrode 441 and a second transparent electrode 442. In the embodiment, the light-tuning panel 420 is a liquid crystal layer, and the light-tuning material 450 is the liquid crystal. In other embodiments, the light-tuning material 450 may be transparent solid crystal or transparent ceramic materials that can change the light beams directions in response to the applied voltage.

The liquid crystal layer is arranged between the lens array 410 and the display panel 430. The dimension of the liquid crystal molecules is the same with the dimension of the lens unit of the lens array 410 along with a horizontal direction of the lens array and the display panel. The borders of the adjacent liquid crystal units align with a center of the lens unit. The first transparent electrode 441 and the second transparent electrode 442 are located at the same side of the display panel 430. In other embodiments, the first transparent electrode 441 and the second transparent electrode 442 may be arranged at respective sides of the lens array 410 and the display panel 430 that are close to the liquid crystal layer. Alternatively, the first transparent electrode 441 and the second transparent electrode 442 may be arranged at one side of the lens array 410. At least one of the first transparent electrode 441 and the second transparent electrode 442 is applied with the voltage so as to form the electrical field.

In an example, the lens array includes eight lens units numbered as 1 through 8. Referring to FIG. 5(a), the display panel 430 displays the left-eye image at the moment (t1). The alignment of the liquid crystal molecules is changed due to the electrical field formed when the electrodes are applied with a first voltage. At this moment, the liquid crystal molecules is equivalent to prism with a first shape. The liquid crystal molecules only transmit the lights beam from the display panel 430 for displaying the left-eye image to the lens of the lens array 410 numbered by 1, 3, 5 and 7. Referring to FIG. 5(b), the display panel 430 displays the right-eye image at the moment (t2). The alignment of the liquid crystal molecules may be changed or remain the same in accordance with the applied second voltage to the electrodes. At this moment, the liquid crystal molecules is equivalent to prism with a second shape. The liquid crystal molecules only transmit the lights beam from the display panel 430 for displaying the right-eye image to the lens of the lens array 410 numbered by 2, 4, 6 and 8.

The time (t1) and (t2) are alternatively repeated in a routine manner for respectively transmitting the left-eye image and the right-eye image to the left and right eye.

FIG. 6 is a schematic view showing the viewing angle of the integral imaging 3D LCD in accordance with one embodiment. The integral imaging 3D LCD includes a lens array 510, a display panel 530, and a light-tuning panel 520 arranged between the lens array 510 and the display panel 530. It can be seen from FIG. 6 that the viewing angle (θ) and the lens pitches of two lens (p) form an equilateral triangle. The distance between the viewing angle (θ) and the display panel 530 equals to the distance (g) between the lens and the sensor. The vertical-bisection line of the lens pitch is the angle bisection line of the viewing angle (θ). Thus,

$$tan \frac{θ}{2} = \frac{p}{2 g} ,$$

and the viewing angle is

$$θ = 2 arctan \frac{p}{2 g} .$$

In view of the above, the light-tuning panel capable of controlling the transmitting directions of the light beams is arranged between the display panel and the micro lens array. The light beams for displaying the left-eye image may be transmitted to the left eye when the electrodes of the light-tuning panel is applied with the first voltage. The light beams for displaying the right-eye image may be transmitted to the right eye when the electrodes of the light-tuning panel is applied with the second voltage. The light-tuning panel remains in the same position with respect to the micro lens array and the liquid crystal panel. The users may experience the 3D effect due to the persistence of vision effect. The viewing angle of the display device is

$$θ = 2 arctan \frac{p}{2 g} .$$

while additional optical apparatus is adopted. The above-mentioned viewing angle is larger than the conventional display device while the movement of the mechanically controlled barrier is adopted to control the light beams for displaying the left-eye image and the right-eye image. In addition, it can also be understood that the movement of the barrier may result in friction and corresponding heat issues, which to some extent decrease the life cycle of the LCD. As the light transmission direction may be controlled by the voltage applied to the liquid crystal in the claimed invention, it is obvious no additional heat is generated. The claimed configuration not only ensures the life cycle of the display device, but also can be easily implemented and controlled.

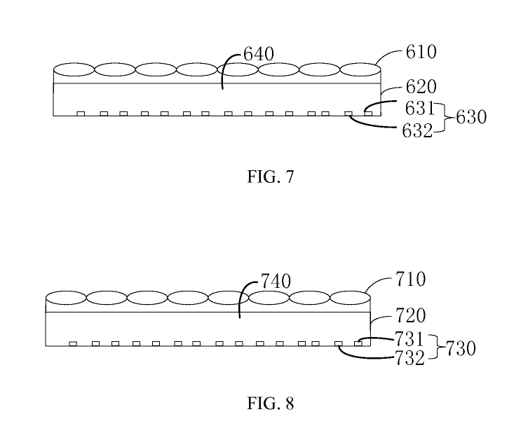

FIG. 7 is a schematic view of the optical apparatus in accordance with one embodiment. The integral imaging 3D LCD includes a lens array 610, a display panel 630, and a light-tuning panel 620 having a plurality of light-tuning units corresponding to different lens or different combinations of the lens of the lens array 610. During the operations, the light-tuning panel 620 remains in the same position with respect to the lens array 610 and the display panel 630. In addition, the integral imaging 3D LCD includes a plurality of electrodes 630 and light-tuning material 640. The electrodes 630 includes a first transparent electrode 631 and a second transparent electrode 632.

In one embodiments, the first transparent electrode 631 and the second transparent electrode 632 may be arranged at respective sides of the lens array and the display panel that are close to the liquid crystal layer. Alternatively, the first transparent electrode 631 and the second transparent electrode 632 may be arranged at one side of the lens array or the display panel. At least one of the first transparent electrode 631 and the second transparent electrode 632 is applied with the voltage so as to form the electrical field. The electrodes 630 is applied with the voltage such that the light-tuning material 640 transmits the light beams from the liquid crystal panel to corresponding lens array so as to change the light transmission direction.

FIG. 8 is a schematic view of the optical apparatus in accordance with another embodiment. The integral imaging 3D LCD includes a lens array 710 and a light-tuning panel 720. The dimension of the light-tuning unit is the same with the dimension of the lens unit of the lens array 710 along with a horizontal direction of the lens array and the display panel. The border of the adjacent light-tuning units aligns with a center of the lens unit. In the embodiment, the light-tuning material 450 is the liquid crystal. In other embodiments, the light-tuning material 450 may be transparent solid crystal or transparent ceramic materials that can change the light transmission directions in response to the applied voltage. The light-tuning panel 720 may include a plurality of liquid crystal molecules. During the operations, the liquid crystal molecules remains in the same position with respect to the lens. The light-tuning panel 720 also includes electrodes 730 and light-tuning material 740. The electrodes 730 includes a first transparent electrode 731 and a second transparent electrode 732.

The first transparent electrode 731 and the second transparent electrode 732 may be arranged at respective sides of the lens array and the display panel that are close to the liquid crystal layer. Alternatively, the first transparent electrode 731 and the second transparent electrode 732 may be arranged at one side of the lens array or the liquid crystal panel. At least one of the first transparent electrode 731 and the second transparent electrode 732 is applied with the voltage so as to form the electrical field. The alignment of the liquid crystal molecules is changed due to the electrical field formed when the electrodes are applied with a first voltage. At this moment, the liquid crystal molecules is equivalent to prism with a first shape such that the light beams are transmitted to the left eye after passing through the lens array. The alignment of the liquid crystal molecules may be changed or remain the same depending on whether the electrodes are applied with a second voltage or not. At this moment, the liquid crystal molecules is equivalent to prism with a second shape such that the light beams are transmitted to the right eye after passing through the lens array.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An integral imaging 3D LCD, comprising:
a lens array, a display panel, a light-tuning panel arranged between the lens array and the display panel, the display panel comprises a plurality of light-tuning units corresponding to different lens or different combinations of the lens of the lens array, the light-tuning panel remains in the same position with respect to the lens array and the display panel during operations, the light-tuning unit comprises electrodes and light-tuning material, when the electrodes are applied with a voltage, the light-tuning material transmits light beams from the display panel to the lens array to change a transmission direction of the light beams;
the light-tuning material is liquid crystal molecule, alignment of liquid crystal molecules is changed due to an electrical field formed when the electrodes are applied with a first voltage, the liquid crystal molecule is equivalent to a prism having a first shape so as to transmit the light beams to a left eye after being passed through the lens array, and the alignment of the liquid crystal molecules is changed or remains the same in accordance with a second voltage applied to the electrodes, the liquid crystal molecule is equivalent to the prism having a second shape so as to transmit the light beams to a right eye after being passed through the lens array;
a dimension of the light-tuning unit is the same with the dimension of the lens unit of the lens array along with a horizontal direction of the lens array and the display panel, and borders of the adjacent light-tuning units align with a center of the lens unit; and
the electrodes comprises a first transparent electrode and a second transparent electrode, and at least one of the first transparent electrode and the second transparent electrode forms an electrical field after being applied with the voltage.

2. The integral imaging 3D LCD as claimed in claim 1, wherein the first transparent electrode and the second transparent electrode are arranged at respective sides of the lens array and the display panel close to the liquid crystal layer, or the first transparent electrode and the second transparent electrode are both arranged at one side of the lens array or the display panel.

3. An integral imaging 3D LCD, comprising:
a lens array, a display panel, and a light-tuning panel arranged between the lens array and the display panel, the display panel comprises a plurality of light-tuning units corresponding to different lens or different combinations of the lens of the lens array, the light-tuning panel remains in the same position with respect to the lens array and the display panel during operations, the light-tuning unit comprises electrodes and light-tuning material, when the electrodes are applied with a voltage, the light-tuning material transmits light beams from the display panel to the lens array to change a transmission direction of the light beams.

4. The integral imaging 3D LCD as claimed in claim 3, wherein the light-tuning material is liquid crystal molecule, alignment of liquid crystal molecules is changed due to an electrical field formed when the electrodes are applied with a first voltage, the liquid crystal molecule is equivalent to a prism having a first shape so as to transmit the light beams to a left eye after being passed through the lens array, and the alignment of the liquid crystal molecules is changed or remains the same in accordance with a second voltage applied to the electrodes, the liquid crystal molecule is equivalent to the prism having a second shape so as to transmit the light beams to a right eye after being passed through the lens array.

5. The integral imaging 3D LCD as claimed in claim 4, wherein a dimension of the light-tuning unit is the same with the dimension of the lens unit of the lens array along with a horizontal direction of the lens array and the display panel, and borders of the adjacent light-tuning units align with a center of the lens unit.

6. The integral imaging 3D LCD as claimed in claim 4, wherein the electrodes comprises a first transparent electrode and a second transparent electrode, and at least one of the first transparent electrode and the second transparent electrode forms an electrical field after being applied with the voltage.

7. The integral imaging 3D LCD as claimed in claim 6, wherein the first transparent electrode and the second transparent electrode are arranged at respective sides of the lens array and the display panel close to the liquid crystal layer, or the first transparent electrode and the second transparent electrode are both arranged at one side of the lens array or the display panel.

8. An optical apparatus for an integral imaging 3D LCD, comprising:
a lens array, a display panel, and a light-tuning panel arranged between the lens array and the display panel, the display panel comprises a plurality of light-tuning units corresponding to different lens or different combinations of the lens of the lens array, the light-tuning panel remains in the same position with respect to the lens array and the display panel during operations, the light-tuning unit comprises electrodes and light-tuning material, when the electrodes are applied with a voltage, the light-tuning material transmits light beams from the display panel to the lens array to change a transmission direction of the light beams.

9. The optical apparatus as claimed in claim 8, wherein the light-tuning material is liquid crystal molecule, alignment of liquid crystal molecules is changed due to an electrical field formed when the electrodes are applied with a first voltage, the liquid crystal molecule is equivalent to a prism having a first shape so as to transmit the light beams to a left eye after being passed through the lens array, and the alignment of the liquid crystal molecules is changed or remains the same in accordance with a second voltage applied to the electrodes, the liquid crystal molecule is equivalent to the prism having a second shape so as to transmit the light beams to a right eye after being passed through the lens array.

10. The optical apparatus as claimed in claim 9, wherein a dimension of the light-tuning unit is the same with the dimension of the lens unit of the lens array along with a horizontal direction of the lens array and the display panel, and borders of the adjacent light-tuning units align with a center of the lens unit.

11. The optical apparatus as claimed in claim 9, wherein the electrodes comprises a first transparent electrode and a second transparent electrode, and at least one of the first transparent electrode and the second transparent electrode forms an electrical field after being applied with the voltage.

12. The optical apparatus as claimed in claim 11, wherein the first transparent electrode and the second transparent electrode are arranged at respective sides of the lens array and the display panel close to the liquid crystal layer, or the first transparent electrode and the second transparent electrode are both arranged at one side of the lens array or the display panel.

13. The optical apparatus as claimed in claim 11, wherein the first transparent electrode and the second transparent electrode are arranged at respective sides of the lens array and the display panel close to the liquid crystal layer, or the first transparent electrode and the second transparent electrode are both arranged at one side of the lens array or the display panel.
